(19) United States
(12) Patent Application Publication
(10) Pub. No.: US 2010/0327587 A1
(43) Pub. Date: Dec. 30, 2010

(54) FUEL GAS GENERATOR

(76) Inventor: Chin-Kuang LUO, Taichung City (TW)

Correspondence Address: FROMMER LAWRENCE & HAUG LLP, 745 FIFTH AVENUE, NEW YORK, NY, 10151, US

(21) Appl. No.: 12/639,981

(22) Filed: Dec. 16, 2009

(30) Foreign Application Priority Data
Jun. 26, 2009 (TW) 098121623
Sep. 30, 2009 (TW) 098133167

(51) Int. Cl. H02P 9/04; F01K 13/02

(52) U.S. Cl. 290/51; 60/660

(57) ABSTRACT

A fuel gas generator includes: a combustion chamber generating thermal energy through combustion of air and fuel gas therein, and supplying the thermal energy to a thermal engine such that the thermal engine is driven to generate kinetic energy that is converted into electrical energy by an electric generator; a temperature sensor for generating a sensing signal indicative of a temperature in the combustion chamber; and a controller for controlling a flow valve coupled to the combustion chamber based on the sensing signal such that the flow valve is switched to an OFF state upon detecting that the temperature is higher than a first temperature, thereby supplying the air and the fuel gas to the combustion chamber therethrough, and to an OFF-state upon detecting that the temperature is lower than a second temperature lower than the first temperature, thereby ceasing supply of the air and the fuel gas to the combustion chamber.

### CROSS-REFERENCE TO RELATED APPLICATION

This application claims priority of Taiwanese Application Nos. 098121623 and 098133167, filed on Jun. 26, 2009 and Sep. 30, 2009, respectively.

### BACKGROUND OF THE INVENTION

1. Field of the Invention

The invention relates to a generator, more particularly to a fuel gas generator.

2. Description of the Related Art

FIG. 1 illustrates a conventional thermal engine 1 disclosed in U.S. Pat. No. 6,779,341 and including a first pneumatic cylinder 11, a second pneumatic cylinder 12, a fluid pipe 15 intercommunicating fluidly the first and second pneumatic cylinders 11, 12, and a flywheel assembly 13 coupled to the first and second pneumatic cylinders 11, 12. Thermal energy from a thermal energy source 2 is applied to a cylinder body 111 of the first pneumatic cylinder 11 to result in an expansion stroke of the first pneumatic cylinder 11 and in rotation of the flywheel assembly 13. The expansion stroke of the first pneumatic cylinder 11 also results in a compression stroke of the second pneumatic cylinder 12. When the first pneumatic cylinder 11 reaches the end of the expansion stroke, due to the presence of the fluid pipe 15, temperature of working gas in the first pneumatic cylinder 11 is reduced, while temperature of working gas in the second pneumatic cylinder 12 is increased, thereby resulting in an expansion stroke of the second pneumatic cylinder 12 and in continued rotation of the flywheel assembly 13. Similarly, the expansion stroke of the second pneumatic cylinder 12 results in a compression stroke of the first pneumatic cylinder 11. Accordingly, continuous rotation of the flywheel assembly 13 is achieved such that kinetic energy is generated from thermal energy and that the kinetic energy is converted into electrical energy by an electric generator 14.

In such a configuration, a mechanical power output generated by the conventional thermal engine 1 depends on the thermal energy generated by the thermal energy source 2. When the thermal energy is generated from solar energy or terrestrial heat, unstable supply of the thermal energy to the first pneumatic cylinder 11 may occur. When the thermal energy is generated by fuel combustion, in order to ensure stable supply of the thermal energy to the first pneumatic cylinder 11, continuous supply of fuel is necessary, thereby resulting in relatively high costs.

### SUMMARY OF THE INVENTION

Therefore, an object of the present invention is to provide a fuel gas generator that has enhanced electric generating efficiency at relatively low costs.

According to the present invention, a fuel gas generator comprises:

a thermal engine;

a thermal energy generating unit including
a combustion chamber in thermal contact with the thermal engine for generating thermal energy through combustion of air and fuel gas supplied thereto and for supplying the thermal energy to the thermal engine such that the thermal engine is driven to generate kinetic energy;

an electric generator coupled to the thermal engine for converting the kinetic energy generated thereby into electrical energy;

a flow valve coupled to the combustion chamber and operable to control supply of the air and the fuel gas to the combustion chamber; and

a control unit including
a temperature sensor for generating a sensing signal indicative of a temperature in the combustion chamber of the thermal energy supplying unit, and
a controller coupled to the temperature sensor and the flow valve, receiving the sensing signal from the temperature sensor, and controlling the flow valve based on the sensing signal received thereby such that the flow valve is operable between an ON state, where the air and the fuel gas are supplied to the combustion chamber through the flow valve, and an OFF state, where supply of the air and the fuel gas to the combustion chamber is ceased.

The flow valve is controlled by the controller to switch from the ON state to the OFF state upon detecting that the temperature in the combustion chamber is higher than a predetermined first temperature and to switch from the OFF state to the ON state upon detecting that the temperature in the combustion chamber is lower than a predetermined second temperature that is lower than the predetermined first temperature.

### BRIEF DESCRIPTION OF THE DRAWINGS

Other features and advantages of the present invention will become apparent in the following detailed description of the preferred embodiment with reference to the accompanying drawings, of which:

FIG. 1 is a partly sectional, schematic top view showing a conventional thermal engine disclosed in U.S. Pat. No. 6,779,341; and

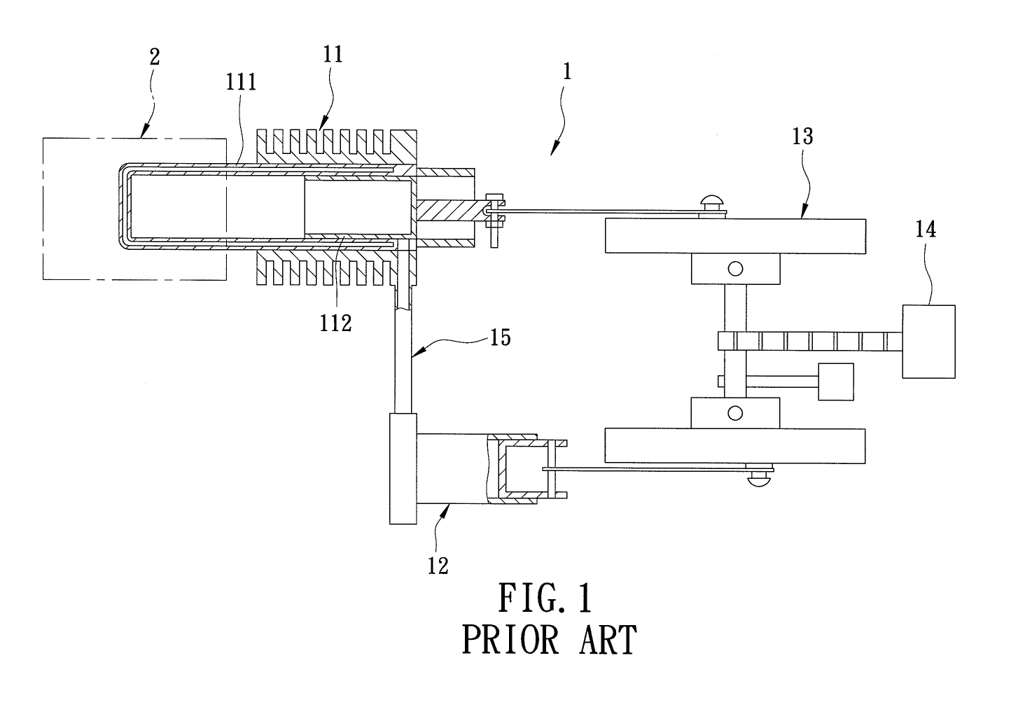

FIG. 2 is a schematic circuit block diagram showing the preferred embodiment of a fuel gas generator according to the present invention.

### DETAILED DESCRIPTION OF THE PREFERRED EMBODIMENT

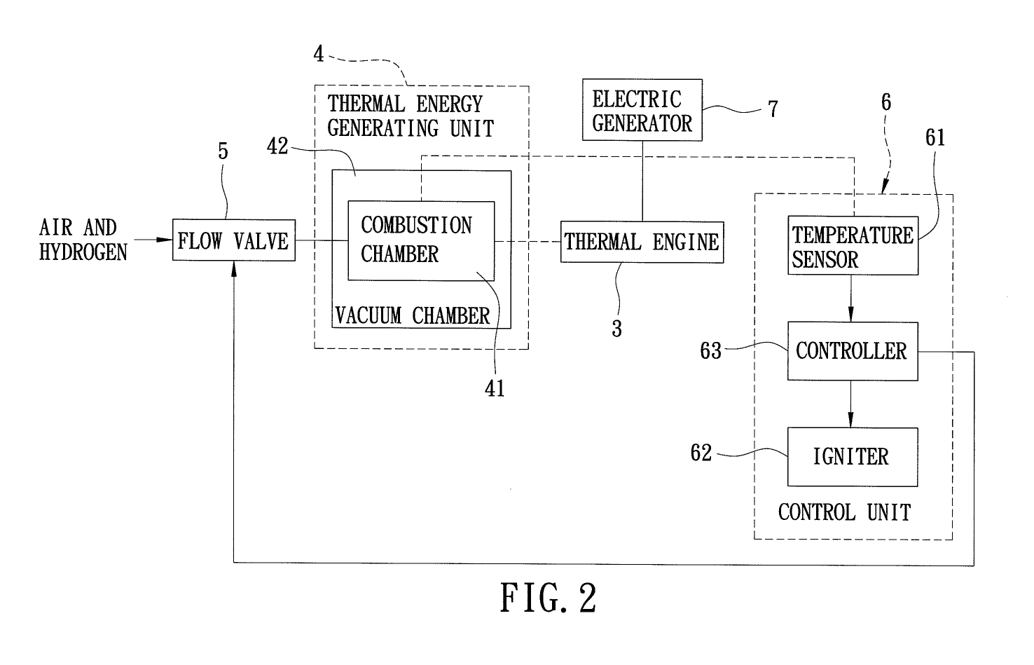

Referring to FIG. 2, the preferred embodiment of a fuel gas generator according to the present invention is shown to include a thermal engine 3, a thermal energy generating unit 4, a flow valve 5, a control unit 6, and an electric generator 7.

The thermal energy generating unit 4 includes a combustion chamber 41 and a vacuum chamber 42. The combustion chamber 41 is in thermal contact with the thermal engine 3 for generating thermal energy through combustion of air and fuel gas supplied thereto and for supplying the thermal energy to the thermal engine 3 such that the thermal engine 3 is driven to generate kinetic energy. In this embodiment, the fuel gas includes hydrogen such that a combustion product is water, thereby conforming to requirements for environmental protection. The combustion product can be discharged via a discharge passage (not shown) in spatial communication with the combustion chamber 41. In other embodiments, the fuel gas can be a hydrocarbon or natural gas.

The vacuum chamber 42 surrounds the combustion chamber 41. It is noted that, due to the presence of the vacuum chamber 42, heat dissipation from the combustion chamber 41 can be minimized, thereby ensuring a superior thermal energy generating efficiency of the thermal energy generating unit 4.

The electric generator 7 is coupled to the thermal engine 3 for converting the kinetic energy generated thereby into electrical energy.

The flow valve 5 is coupled to the combustion chamber 41 of the thermal energy generating unit 4, and is operable to control supply of the air and the fuel gas to the combustion chamber 41 of the thermal energy generating unit 4.

The control unit 6 includes a temperature sensor 61, an igniter 62 and a controller 63. The temperature sensor 61 senses a temperature in the combustion chamber 41 of the thermal energy generating unit 4, and generates a sensing signal indicative of the temperature in the combustion chamber 41. The igniter 62 is disposed in the combustion chamber 41, and is operable to ignite the fuel gas in the combustion chamber 41. The controller 63 is coupled to the temperature sensor 61, the igniter 62 and the flow valve 5, and receives the sensing signal from the temperature sensor 61. The controller 63 controls the flow valve 5 based on the sensing signal received thereby such that the flow valve 5 is operable between an ON-state, where the air and the fuel are supplied to the combustion chamber 41 of the thermal energy generating unit 4 through the flow valve 5, and an OFF-state, where supply of the air and the fuel gas to the combustion chamber 41 of the thermal energy generating unit 4 is ceased. Thus, the flow valve 5 is controlled by the controller 63 of the control unit 6 to switch from the ON-state to the OFF-state upon detecting that the temperature in the combustion chamber 41 of the thermal energy generating unit 4 is higher than a predetermined first temperature (T1), and to switch from the OFF-state to the ON-state upon detecting that the temperature in the combustion chamber 41 of the thermal energy generating unit 4 is lower than a predetermined second temperature (T2) that is lower than the predetermined first temperature (T1), i.e., T1>T2. When the flow valve 5 is switched from the OFF-state to the ON-state, the igniter 62 is activated through control of the controller 63 to ignite the fuel gas in the combustion chamber 41 of the thermal energy generating unit 4.

In sum, since the vacuum chamber 42 of the thermal energy generating unit 4 can ensure a superior thermal energy generating efficiency of the thermal energy generating unit 4 and since the air and the fuel gas are supplied intermittently to the combustion chamber 41 of the thermal energy generating unit 4 through control of the flow valve 5, the temperature in the combustion chamber 41 of the thermal energy generating unit 4 can be maintained at the predetermined second temperature (T2) with a relatively small amount of the fuel gas. Thus, stable kinetic energy can be generated by the thermal engine 3 at relatively low fuel costs. Therefore, the fuel gas generator of the present invention can attain required electric generating effect and ensure stable electric generation at relatively low costs.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A fuel gas generator comprising:
a thermal engine;
a thermal energy generating unit including
a combustion chamber in thermal contact with said thermal engine for generating thermal energy through combustion of air and fuel gas supplied thereto and for supplying the thermal energy to said thermal engine such that said thermal engine is driven to generate kinetic energy;
an electric generator coupled to said thermal engine for converting the kinetic energy generated thereby into electrical energy;
a flow valve coupled to said combustion chamber and operable to control supply of the air and the fuel gas to said combustion chamber; and
a control unit including
a temperature sensor for generating a sensing signal indicative of a temperature in said combustion chamber of said thermal energy supplying unit, and
a controller coupled to said temperature sensor and said flow valve, receiving the sensing signal from said temperature sensor, and controlling said flow valve based on the sensing signal received thereby such that said flow valve is operable between an ON-state, where the air and the fuel gas are supplied to said combustion chamber through said flow valve, and an OFF-state, where supply of the air and the fuel gas to said combustion chamber is ceased;
wherein said flow valve is controlled by said controller to switch from the ON-state to the OFF-state upon detecting that the temperature in said combustion chamber is higher than a predetermined first temperature and to switch from the OFF-state to the ON-state upon detecting that the temperature in said combustion chamber is lower than a predetermined second temperature that is lower than the predetermined first temperature.

2. The fuel gas generator as claimed in claim 1, wherein said thermal energy generating unit further includes a vacuum chamber surrounding said combustion chamber.
